(19) United States
(12) Patent Application Publication
(10) Pub. No.: US 2010/0013336 A1
(43) Pub. Date: Jan. 21, 2010

(54) Anchoring System For A Stator Housing Assembly Having An Overmolding; Power Tool With Same

(75) Inventors: Earl M. Ortt, Bel Air, MD (US); David J. Smith, Columbia, MD (US); Eric E. Hatfield, Jacobus, PA (US)

Correspondence Address: THE BLACK & DECKER CORPORATION, 701 EAST JOPPA ROAD, TW199, TOWSON, MD, 21286, US

(73) Assignee: BLACK & DECKER INC., Newark, DE (US)

(21) Appl. No.: 12/443,196

(22) PCT Filed: Oct. 12, 2007
(86) PCT No.: PCT/US07/21797

§ 371 Date: Mar. 27, 2009

Related U.S. Application Data
(60) Provisional application No. 60/851,813, filed on Oct. 13, 2006.

(51) Int. Cl. H02K 1/18; H02K 7/14

(52) U.S. Cl. 310/154.03; 29/598; 310/50; 310/43

(57) ABSTRACT

A permanent magnet electric motor has a stator and a rotor The stator has a stator housing with opposed axial ends and features skived in the stator housing to extend radially inwardly from an inner surface of the stator housing proximate to at least one of the axial ends of the stator housing. An overmolding of material is molded around the features. In an aspect, the overmolding of material is a magnetic composite material and is molded to form magnets. In an aspect, magnets are placed on the inner surface of the stator housing and the overmolding of material is a plastic that is over molded around the magnets and the features. In an aspect, the features hold the magnets in place during the molding of the overmolding around the magnets. In an aspect, the magnets have essentially the same inner radius and outer radius and the overmolding of material is thicker at edges of each magnet than at the center of each magnet. In an aspect, the magnets are flat magnets and the overmolding of material is thicker at edges of each magnet than at the center of each magnet. In an aspect a power tool has such a permanent magnet DC motor. In an aspect, a power tool has a housing with a permanent magnet electric motor in the housing, with an member coupled to the electric motor. The electric motor has a rotor and a stator but not an end plate. The stator has a stator housing having opposed axial ends and a plurality of magnets affixed to an inner surface of the stator housing and an overmolding of material molded around the magnets. The overmolding of material includes a pilot feature that mates with a pilot feature of a bearing support of the power tool.

### CROSS-REFERENCE TO RELATED APPLICATIONS

This application claims the benefit of U.S. Provisional Application No. 60/851,813 filed on Oct. 13, 2006. The disclosure of the above application is incorporated herein by reference.

### FIELD

The present disclosure relates to power tools and electric motors therefore including permanent magnet DC motors in which a stator has a stator housing assembly having a housing to which permanent magnets are affixed to an inner surface thereof and overmolded with plastic. It also relates to power tools and electric motors therefore in which composite magnetic material is molded on the inner surfaces of the stator housing to form magnets.

### BACKGROUND

In U.S. Pat. Nos. 6,522,042, 6,983,529 and 7,088,024, it is described that anchors for stator housings are formed in the housing or a flux ring, magnets are placed in the housing or flux ring such as between the anchors, and a plastic material is overmolded that fills around the anchors to secure the magnets to the flux ring or housing. It is also described that, alternatively, a magnet composite material is molded in the flux ring or housing and fills around the anchors to form molded magnets that are held in place in by the anchors. The entire disclosures of U.S. Pat. Nos. 6,522,042, 6,983,529 and 7,088,024 are incorporated by reference herein.

### SUMMARY

In accordance with an aspect of the present disclosure, a permanent magnet electric motor has a stator and a rotor. The stator has a stator housing with opposed axial ends and features skived in the stator housing to extend radially inwardly from an inner surface of the stator housing proximate to at least one of the axial ends of the stator housing. An overmolding of material is molded around the features. In an aspect, the overmolding of material is a magnetic composite material and is molded to form magnets. In an aspect, magnets are placed on the inner surface of the stator housing and the overmolding of material is a plastic that is over molded around the magnets and the features.

In an aspect, the features hold the magnets in place during the molding of the overmolding around the magnets.

In an aspect, the magnets have essentially the same inner radius and outer radius and the overmolding of material is thicker at edges of each magnet than at the center of each magnet.

In an aspect, the magnets are flat magnets and the overmolding of material is thicker at edges of each magnet than at the center of each magnet.

In an aspect a power tool has such a permanent magnet DC motor.

In an aspect, a power too has a housing with a permanent magnet electric motor in the housing, with an member coupled to the electric motor. The electric motor has a rotor and a stator but not an end plate. The stator has a stator housing having opposed axial ends and a plurality of magnets affixed to an inner surface of the stator housing and an overmolding of material molded around the magnets. The overmolding of material includes a pilot feature that mates with a pilot feature of a bearing support of the power tool.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side perspective view of a prior art power tool;

FIG. 2 is a side end view of a stator housing having skived anchors in accordance with an aspect of the present disclosure;

FIG. 3 is a section taken along the line 3-3 of FIG. 2;

FIG. 4 is a perspective view showing an empty stator housing with skived anchors in the ID of the stator housing around the peripheries of both axial ends of the stator housing;

FIG. 5 is a perspective view showing the stator housing of FIG. 4 with magnets placed on the inner surface of the stator housing between the skived anchors;

FIG. 6 is a perspective view showing the stator housing of FIG. 4 with an overmolding around the magnets and skived anchors; and

FIG. 7 is a perspective view showing a power tool with a bearing support combined with a ring gear housing piloted by the overmolding in accordance with an aspect of the present disclosure; and

FIG. 8 is a perspective view of a stator housing having flat magnets on an inner surface of the stator housing with an overmolding of material therearound in accordance with an aspect of the present disclosure.

### DETAILED DESCRIPTION

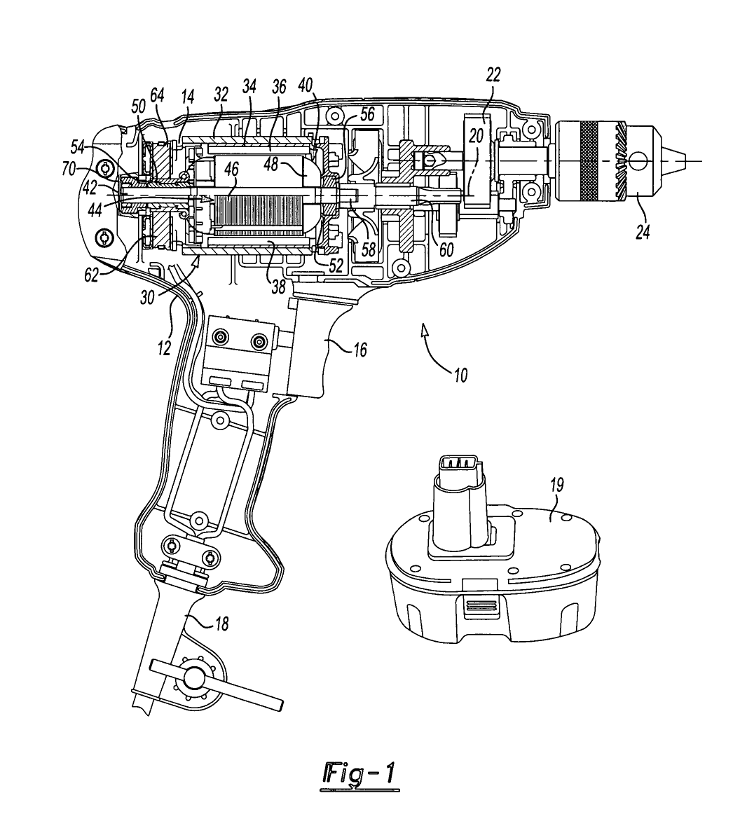

Referring now to FIG. 1, a prior art power tool 10 is shown. The power tool 10 includes a housing 12 which surrounds a motor 14. An activation member 16 is coupled with the motor and a power source 18. The power source 18 includes either a power cord (AC current) or includes a battery pack 19 (DC current). The motor 14 is coupled with an output member 20 that includes a transmission 22 and a chuck 24. The chuck 24 is operable to retain a tool (not shown).

The motor includes a stator assembly 30. The stator assembly 30 includes a stator housing 32, a flux ring 34 and magnets 36. The flux ring 34 is an expandable or split flux ring. An armature 40 includes a shaft 42, a rotor 44 and a commutator 50 coupled with the shaft 42. The rotor 44 includes laminations 46 and windings 48. The motor 14 also includes end plates 52 and 54. End plate 52 includes a front bearing 56 which supports one end of a shaft 42. The shaft 42 is coupled with a pinion 60 that is part of the output member 20. Brushes 62 and 64 are associated with the commutator 50. A rear bearing 70 is also coupled with the end plate 54 to balance rotation of the shaft 42.

While motor 14 is illustratively shown as a permanent magnet DC (“PMDC”) motor in which magnets 36 are affixed to an inner surface of flux ring 34, it should be understood that motor 14 could be other types of motors that utilize permanent magnets, such as a brushless motor in which the rotor has permanent magnets and the stator has electronically commutated windings. Referring now to FIG. 1, a prior art power tool 10 is shown in which a motor in accordance with aspects of the present disclosure can be used. The power tool 10 is illustrated as a drill, however, any type of power tool may be used in accordance with the present invention. The power tool 10 includes a housing 12 which surrounds a motor 14. An activation member 16 is coupled with the motor and a power source 18. The power source 18 includes either a power cord (AC current) or includes a battery (DC current) (not shown). The motor 14 is coupled with an output member 20 that includes a transmission 22 and a chuck 24. The chuck 24 is operable to retain a tool (not shown).

The motor includes a stator assembly 30. The stator assembly 30 includes a stator housing 32, a flux ring 34 and magnets 36. The flux ring 34 is an expandable or split flux ring. An armature 40 includes a shaft 42, a rotor 44 and a commutator 50 coupled with the shaft 42. The rotor 44 includes laminations 46 and windings 48. The motor 14 also includes end plates 52 and 54. End plate 52 includes a front bearing 56 which supports one end of a shaft 42. The shaft 42 is coupled with a pinion 60 that is part of the output member 20. Brushes 62 and 64 are associated with the commutator 50. A rear bearing 70 is also coupled with the end plate 54 to balance rotation of the shaft 42.

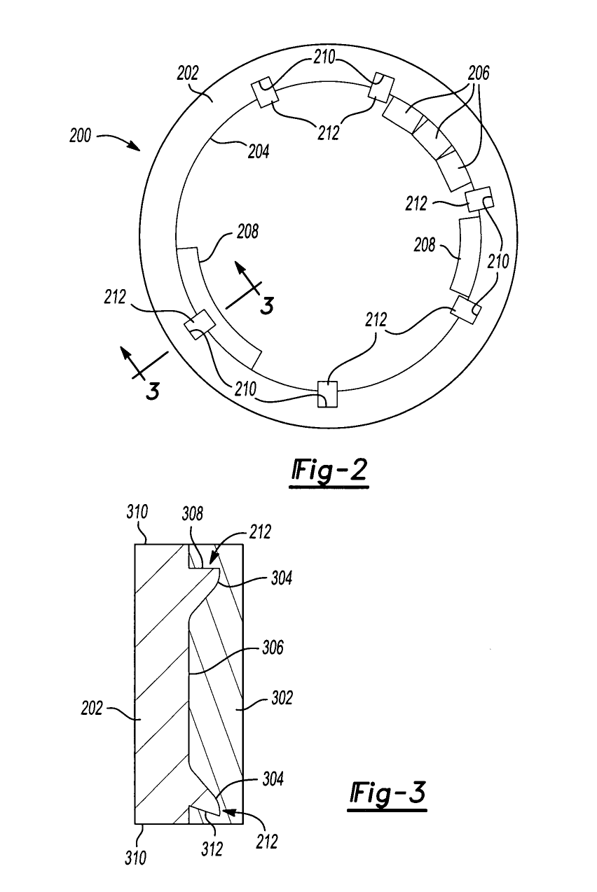

Referring FIG. 2, in accordance with an aspect of the present disclosure, a stator assembly 200 includes a stator housing 202 have magnets affixed to inner surface 204 of stator housing 202. The magnets can be flat magnets, designated with reference number 206 or arcuate magnets, designated with reference number 208 For illustrative purposes, stator assembly 200 is shown as having both flat and arcuate magnets, but it should be understood that stator assembly 200 would typically have either all flat magnets or all arcuate magnets.

The magnets may illustratively be formed placing stator housing 202 in a mold and molding a magnet composite material on inner surface 204 of stator housing 202. The magnets may alternatively be preformed, placed on inner surface 204 of stator housing 202 and affixed thereto.

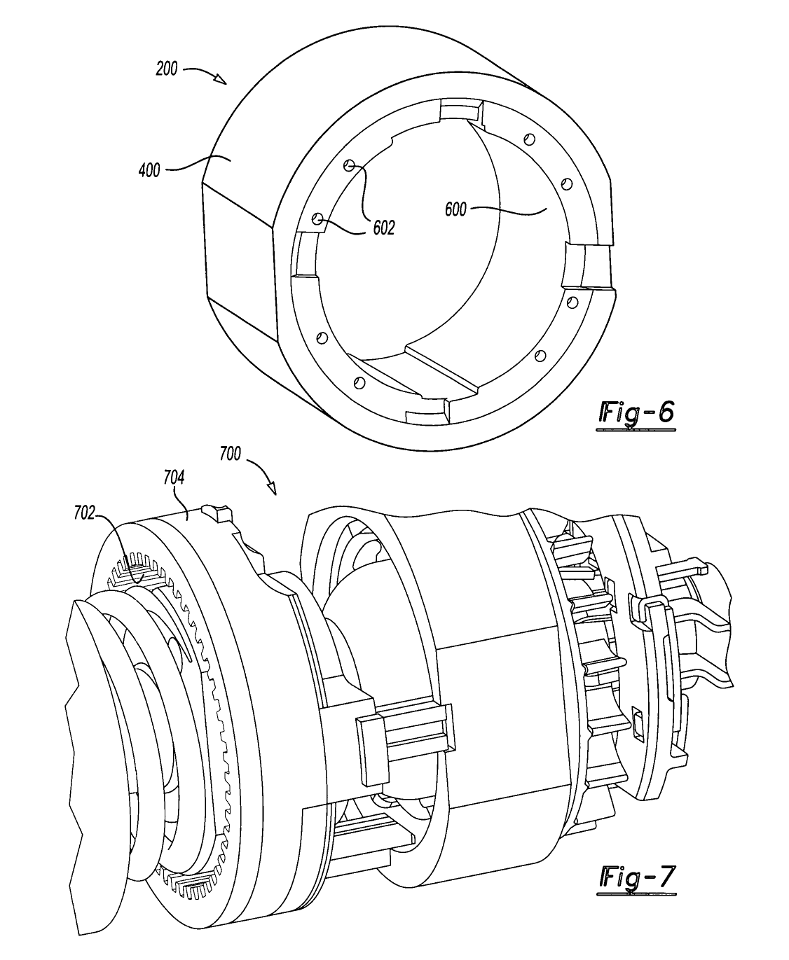

Material of the stator housing 202 is skived at 210 to create features 212 (FIG. 3) therein in which a molding 302 of either a magnet composite or an overmolding, such as of plastic, molds around. The features may illustratively be raised features 304 and may also include recesses 306. With several of these features 212 on the stator housing 202, the molded part, such overmolding 600 (FIG. 6) or molded magnets is well retained within the stator housing 202 axially and angularly. Additionally, these features 212 can be created using a die set and appropriate tooling so that their angular spacing is precisely controlled. Thus they may be used as the angular locators of the magnets during the molding process in which the overmolding is molded. For example, as shown in FIG. 5, arcuate magnets 208 are retained between features 212 in stator housing 202 prior to being overmolded.

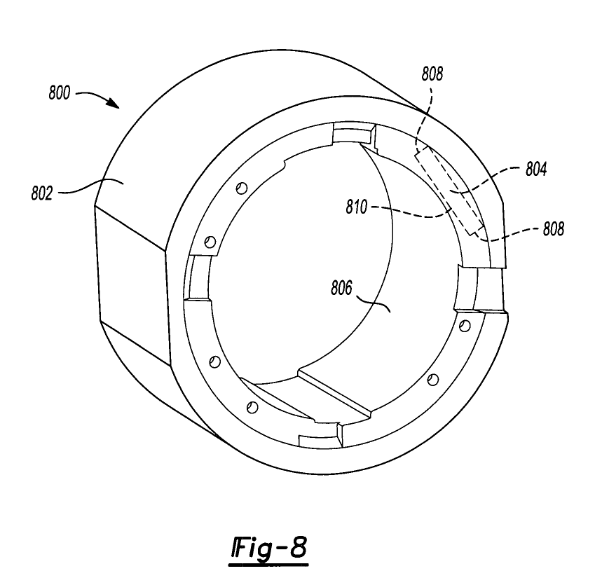

Axially outer ends of the features 212 can be parallel (shown at 308) with the ends 310 of the stator housing 202). The axially outer ends of features 212 may alternatively angled slightly (shown at 312) to better key the plastic of the overmolding radially to inner surface 204 of the stator housing 202. The axial outer ends of the features 212 may also be chamfered (as shown at 800 in FIG. 8). Axially inner ends 314 of features 212 may be raised above the inner surface 204 of the stator housing 202 to retain overmolding 600 (FIG. 6) axially within the stator housing.

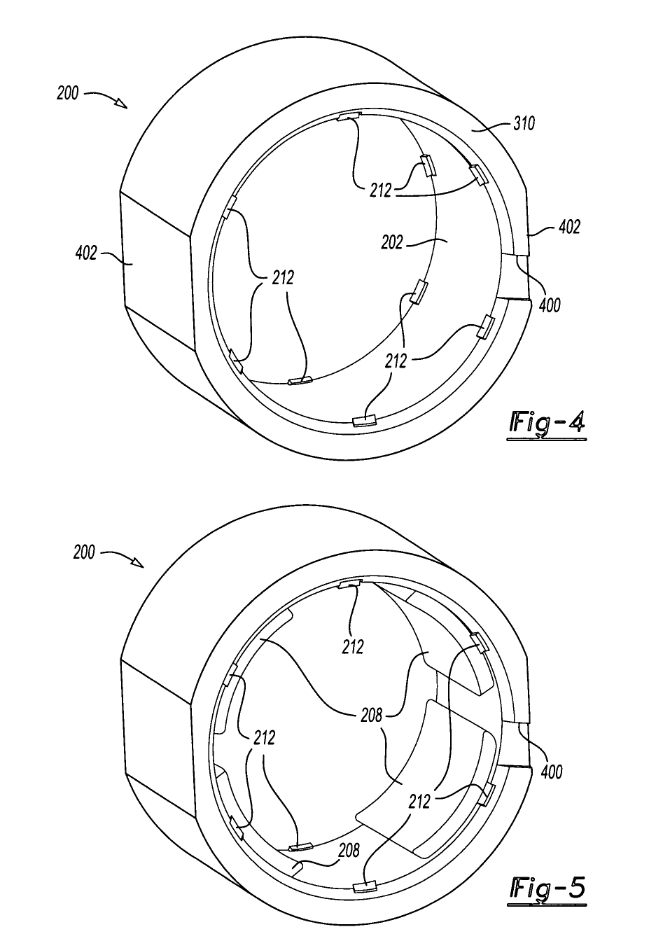

In an aspect, with reference to FIG. 4, stator housing 202 has skived features 212 formed around the peripheries of both axial ends 310 (only one of which is shown in FIG. 4) of stator housing 402. At least one of the axial ends 310 includes a notch 400 therein. The skived features 212 act as anchors and prevent overmolding 600 (FIG. 6) from rotating in stator housing 202. Notch 400 in one or both axial ends 310 of stator housing 202 and flats 404 on outer surface 406 of stator housing 202 cooperate to prevent stator housing 202 from rotating in the power tool housing, such as housing 12 of power tool 10. Also, flats 404 may illustratively be used to key the stator housing 202 in housing 12 of power tool 10.

In such a process, the magnets could be partially or fully magnetized so that they are self-retained against inner surface 204 of the stator housing 202. Locating pins in the molding tool can additionally be used to position the magnets axially within the stator housing 202. Thus after molding, the magnets are in the proper position and well-secured in the stator housing 202. In such a case, the magnet arcs could be arcuate in shape, or they could be flat magnets as described in the patent application titled “Motor Can and Magnet Manufacturing Design,” (attorney docket no. 0275K-001245) filed concurrently herewith, the entire disclosure of which is incorporated herein by reference. And multiple flat magnets could be placed between the skived anchors, as shown in FIG. 2.

In a variation, the magnets may be un-magnetized and features in the mold tooling may be used to properly locate and retain the magnets during the molding process. Or, the magnets may be glued to the stator housing 202 to locate and secure them to the stator housing 202 for molding. Or, the magnets could be adhered to the stator housing 202 by means of a double sided adhesive.

The stator housing could be made using the drawn over mandrel (DOM) process, or it could be made from stamped and rolled housings. For the magnets, they can be pre-formed discrete magnets, or they could be a composite blend of magnet and polymer material that is molded directly into the stator housing 202. In the case of discrete magnets, they could be of various compositions, including but not limited to ferrite, sintered NdFeB, compression bonded NdFeB.

During the overmolding process, if the magnets are designed having the “same OR and IR”, or are flat magnets, as described in the above referenced patent application titled “Motor Can and Magnet Manufacturing Design,” this provides the additional benefit of the overmolding having thicker molded walls at the edges of the magnets. This benefit can be used in either of two ways. First, the thicker molding at the edges of the magnets provides increased strength for magnet retention. Secondly, the wall thickness of the overmolding at the center of the magnets can be minimized, or made to essentially zero, while still having sufficient wall thickness at the edges of the magnet for sufficient magnet retention and a feasible molding process. FIG. 8 shows a stator assembly 800 having a stator housing 802 with a plurality of flat magnets 804 (only one of which is shown in FIG. 8) affixed to an inner surface of the stator housing 802 by an overmolding 806 of material. Overmolding 806 is thicker at edges 808 of magnets 804 than at center 810 of magnets 804. In an aspect, overmolding 806 is at least twenty percent thicker at the edges 808 of magnets 804 than at the center 810 of magnets 804. It should be understood that magnets 804 can also be arcuate magnets having the same OR and IR.

FIG. 38A of U.S. Pat. No. 7,088,024 describes the motor end plate piloted by the overmolding. With reference to FIG. 7, in accordance with an aspect of the present disclosure, functional parts of power tool 700, such as gear case/ring gear 702, are piloted by the overmolding where there is no separate motor end plate. That is, the end plate is functionally combined into other parts of the power tool—such as shown at 704 in FIG. 7 showing a bearing support combined with a ring gear housing. (Note the overmolding is not shown in FIG. 7.) But in the case of overmolding, the armature bearing support, hence alignment of the armature within the overmolding, is improved with less tolerance stackups. FIG. 6 shows pilot features 602, such as holes, in overmolding 600 that pilots bearing support/ring gear housing 704.

The above provides the advantages of a robust means of holding the magnets to a stator housing. Also, formed pilot features in the overmolding can be used to align the front bearing & armature shaft to the inner surface of the overmolding for reduced chances of the armature stack contacting the overmolding.

Overmolding also provides the advantage of improving corrosion resistance of magnets, especially for NdFeB magnets, which are prone to corrosion. Overmolding also allows the use of alternative magnet grades or coatings that are less expensive. Overmolding also provides a method of discrete magnet retention that lessens the dependency on the quality of the magnet gluing process or the quality of the magnet coating process.

1. A power tool, comprising:
a housing;
a permanent magnet electric motor in the housing, the electric motor including a rotor and a stator, the stator having a stator housing having opposed axial ends and a plurality of magnets affixed to an inner surface of the stator housing, a plurality of features projecting radially inwardly from an inner surface of the stator housing, each feature proximate an axial end of the stator housing, and an overmolding of material molded around the features and magnets; and
an output member coupled to the electric motor.

2. The apparatus of claim 1 including anchors projecting from the inner surface of the stator housing with each permanent magnet disposed between a pair of opposed anchors with axially extending edges of each magnet adjacent an anchor, the overmolding of material also molded around the anchors.

3. The apparatus of claim 1 wherein the features are parallel with the axial ends of the stator housing.

4. The apparatus of claim 1 wherein the features are angled with respect to the axial ends of the stator housing.

5. The apparatus of claim 1 wherein the features include features proximate to each axial end of the stator housing with the axial edges of the magnets disposed between opposed ones of the features.

6. The apparatus of claim 1 wherein the magnets are arcuate magnets having essentially the same inner radius and outer radius and the overmolding of material is thicker at edges of the magnets than at centers of the magnets.

7-9. (canceled)

10. A permanent magnet electric motor, comprising:
a stator and a rotor;
the stator having a stator housing having opposed axial ends and a plurality of magnets affixed to an inner surface of the stator housing;
a plurality of features projecting radially inwardly from an inner surface of the stator housing, each feature proximate an axial end of the stator housing, and
an overmolding of material molded around the features and magnets.

11. The apparatus of claim 10 including anchors projecting from the inner surface of the stator housing with each permanent magnet disposed between a pair of opposed anchors with axially extending edges of each magnet adjacent an anchor, the overmolding of material also molded around the anchors.

12. The apparatus of claim 10 wherein the features are parallel with the axial ends of the stator housing.

13. The apparatus of claim 10 wherein the features are angled with respect to the axial ends of the stator housing.

14. The apparatus of claim 10 wherein the features include features proximate to each axial end of the stator housing with the axial edges of the magnets disposed between opposed ones of the features.

15. The apparatus of claim 10 wherein the magnets are arcuate magnets having essentially the same inner radius and outer radius and the overmolding of material is thicker at edges of the magnets than at center of the magnets.

16-18. (canceled)

19. A power tool, comprising:
a housing;
a permanent magnet electric motor in the housing, the electric motor including a rotor and a stator, the stator having a stator housing having opposed axial ends, a plurality of features projecting radially inwardly from an inner surface of the stator housing, each feature proximate an axial end of the stator housing, a plurality of magnets, each magnet molded of magnetic material molded in the stator housing and around at least one of the features; and
an output member coupled to the electric motor.

20. The apparatus of claim 19 wherein the features are parallel with the axial ends of the stator housing.

21. The apparatus of claim 19 wherein the features are angled with respect to the axial ends of the stator housing.

22. The apparatus of claim 19 wherein the features include features proximate to each axial end of the stator housing.

23. A permanent magnet electric motor, comprising:
a rotor and a stator;
the stator having a stator housing having opposed axial ends and a plurality of features projecting radially inwardly from an inner surface of the stator housing, each feature proximate an axial end of the stator housing; and
a plurality of magnets, each magnet molded of magnetic material molded in the stator housing and around at least one of the features.

24. The apparatus of claim 23 wherein the features are parallel with the axial ends of the stator housing.

25. The apparatus of claim 23 wherein the features are angled with respect to the axial ends of the stator housing.

26. The apparatus of claim 23 wherein the features include features proximate to each axial end of the stator housing.

27-29. (canceled)
